(19) United States
(12) Patent Application Publication
(10) Pub. No.: US 2021/0230916 A1
(43) Pub. Date: Jul. 29, 2021

(54) CONCEALED HINGE WITH V-SHAPED ROTATING SHAFTS

(71) Applicant: DALIAN GOLDEN BUTTERFLY TECHNOLOGY CO., LTD., Liaoning (CN)

(72) Inventor: Mingyan WANG, Heilongjiang (CN)

(21) Appl. No.: 17/058,127

(22) PCT Filed: Apr. 30, 2019
(86) PCT No.: PCT/CN2019/085193

§ 371 Date: Nov. 23, 2020

(30) Foreign Application Priority Data
May 22, 2018 (CN) 201810493145.8

(51) Int. Cl. E05D 3/10; E05D 5/02

(52) U.S. Cl. CPC E05D 3/10; E05D 5/02; E05Y 2900/148; E05Y 2900/132; E05Y 2600/41

(57) ABSTRACT

A concealed hinge with V-shaped rotating shafts includes an upper leaf (6) and an upper support arm (4) that are hinged to a secondary hinge (1), and a lower leaf (7) and a lower support arm (5) that are hinged to a primary hinge (8). The upper leaf (6) is hinged to the lower leaf (7). The upper support arm (4) is hinged to the lower support arm (5). A hinged joint at an end of the upper leaf (6) is connected, by means of a shaft (2), to a hinged seat secured to the secondary hinge (1). A hinged joint at one end of the lower leaf (7) is connected, by means of a shaft (2), to a hinged seat secured to the primary hinge (8), and a hinged joint at the other end of the lower leaf (7) is connected to the upper leaf (6) by means of a shared shaft (3). One end of the upper support arm (4) is connected, by means of a side shaft (10), to the hinged seat secured to the secondary hinge (1), and a hinged joint at the other end of the upper support arm (4) is connected to the lower support arm (5) by means of a longitudinal shared shaft (11). A hinged joint at an end of the lower support arm (5) is connected, by means of a side shaft (10), to the hinged seat secured to the primary hinge (8). The concealed hinge is reasonable in structure design, simple and convenient to mount, safe and capable of preventing burglary, extensive in application, small in space usage and convenient to mount and transport, and has good appearance.

### TECHNICAL FIELD

The disclosure relates to an opening and closing mechanism, and specifically, to a concealed hinge with V-shaped rotating shafts.

### BACKGROUND

An opening and closing mechanism is a mechanical device for connecting two objects that rotate relative to each other and allowing for rotation between the two. Most existing opening and closing mechanisms are hinges, and usually used for doors and windows. A door or window hinge has one side secured to a frame of a door or a window and the other side secured to a door leaf or a window sash with a central rotating shaft on the outer side of the door or the window, thereby realizing opening and closing of the door or the window. Existing hinges have the following defects: 1, poor appearance: a traditional hinge may look bad with its hinged part exposed after being closed, and it is difficult to clean and maintain and prone to damage; 2, failure in prevention of burglary: the exposed central rotating shaft is easy to destroy; 3, low strength and small range of application scope: to improve the strength, the thickness needs to be increased, leading to high cost and large weight; 4, inflexible rotation of a traditional hinge after being used for a long time: with load concentrated on the bottom hinged part, the hinged part is highly prone to damage; and 5, poor sound insulation: the sound insulation effect is poor due to a large gap between a door and a frame. Therefore, it is necessary to design a concealed hinge with V-shaped rotating shafts with good appearance, high strength and long service life.

### SUMMARY

The disclosure aims to provide a concealed hinge with V-shaped rotating shafts with good appearance, high strength and long service life. A primary hinge and a secondary hinge of the hinge are opened and closed by means of hinged leaves; and the closed hinge is concealed in a groove of the primary leaf, which may look good and may be not prone to damage and convenient to maintain. The design of the leaves and the support arms improves the strength of the hinge and increases the service life of the hinge.

The technical solution adopted in the disclosure is as follows: a concealed hinge with V-shaped rotating shafts includes an upper leaf and an upper support arm that are hinged to a secondary hinge, and a lower leaf and a lower support arm that are hinged to a primary hinge. The upper leaf is hinged to the lower leaf. The upper support arm is hinged to the lower support arm.

Further, there is one or more folded leaves formed after the upper leaf and lower leaf are hinged and assembled.

Further, there is one or more folded arms formed after the upper support arm and lower support arm are hinged and assembled.

Further, a hinged joint at an end of the upper leaf is connected, by means of a shaft, to a hinged seat secured to the secondary hinge; a hinged joint at one end of the lower leaf is connected, by means of a shaft, to a hinged seat secured to the primary hinge, and a hinged joint at the other end of the lower leaf is connected to the upper leaf by means of a shared shaft; one end of the upper support arm is connected, by means of a side shaft, to the hinged seat secured to the secondary hinge, and a hinged joint at the other end of the upper support arm is connected to the lower support arm by means of a longitudinal shared shaft; and a hinged joint at an end of the lower support arm is connected, by means of a side shaft, to the hinged seat secured to the primary hinge.

Further, the shared shaft for the folded secondary hinge and primary hinge and two shafts intersect at a point.

Further, a groove capable of accommodating folded upper leaf and lower leaf and folded upper support arm and lower support arm is formed in the primary hinge.

Further, a groove capable of accommodating the upper leaf is formed in the lower leaf.

Further, mounting holes or threaded holes are formed in the secondary hinge and the primary hinge.

The disclosure has the following advantages: there is provided a concealed hinge with V-shaped rotating shafts with good appearance, high strength and long service life. The primary hinge and the secondary hinge of the hinge are opened and closed by means of hinged leaves; and the closed hinge is concealed in the groove of the primary leaf, which may look good and may be not prone to damage and convenient to maintain. The design of the leaves and the support arms improves the strength of the hinge and increases the service life of the hinge. The concealed hinge is reasonable in structure design, simple and convenient to mount, safe and capable of preventing burglary, extensive in application, low in cost, durable, and prone to large-scale popularization and use. In addition, the concealed hinge has no obvious protrusion after being mounted and is small in space usage and convenient to mount and transport.

### BRIEF DESCRIPTION OF THE DRAWINGS

FIG. 1 is a schematic diagram illustrating a structure according to example 1 of the disclosure.

FIG. 2 is a top view of a closed hinge in example 1.

FIG. 3 is a schematic diagram illustrating a structure according to example 2 of the disclosure.

### DETAILED DESCRIPTION

### Example 1

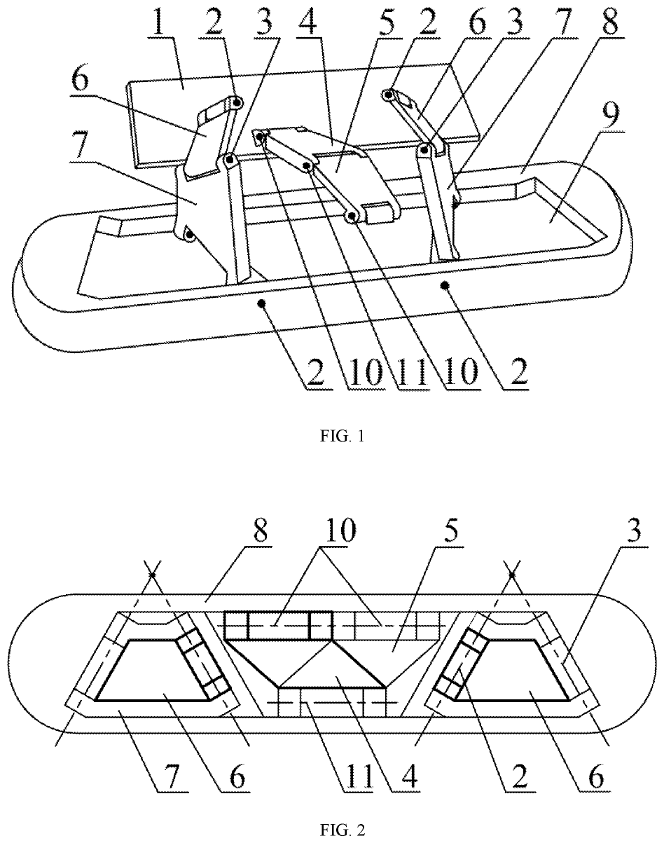

Referring to FIG. 1 and FIG. 2, a concealed hinge with V-shaped rotating shafts includes an upper leaf 6 and an upper support arm 4 that are hinged to a secondary hinge 1, and a lower leaf 7 and a lower support arm 5 that are hinged to a primary hinge 8. The upper leaf 6 is hinged to the lower leaf 7. The upper support arm 4 is hinged to the lower support arm 5. A hinged joint at an end of the upper leaf 6 is connected, by means of a shaft 2, to a hinged seat secured to the secondary hinge 1. A hinged joint at one end of the lower leaf 7 is connected, by means of a shaft 2, to a hinged seat secured to the primary hinge 8, and a hinged joint at the other end of the lower leaf 7 is connected to the upper leaf 6 by means of a shared shaft 3. One end of the upper support arm 4 is connected, by means of a side shaft 10, to the hinged seat secured to the secondary hinge 1, and a hinged joint at the other end of the upper support arm 4 is connected to the lower support arm 5 by means of a longitudinal shared shaft 11. A hinged joint at an end of the lower support arm 5 is connected, by means of a side shaft 10, to the hinged seat secured to the primary hinge 8. The shared shaft 3 for the folded secondary hinge 1 and primary hinge 8 and two shafts 2 intersect at a point. A groove 9 capable of accommodating folded upper leaf 6 and lower leaf 7 and folded upper support arm 4 and lower support arm 5 is formed in the primary hinge 8. A groove capable of accommodating the upper leaf 6 is formed in the lower leaf 7. Mounting holes or threaded holes are formed in the secondary hinge 1 and the primary hinge 8.

When the concealed hinge is in closed state, the folded upper leaf and lower leaf and folded upper support arm and lower support arm are concealed in the groove of the primary hinge, and the secondary hinge is fastened to the top end of the groove of the primary hinge. When the hinge is opened, guided by a guide structure of hinged shafts in V-shaped configuration, the folded leaf is rotated for opening along each hinged shaft at a designed angle. During opening and closing, the V-shaped configuration structure has a compensating effect, where a long edge of the V-shaped structure is capable of compensating a large distance and a short edge of the same is capable of compensating a small distance. With the increase of the opening angle of the V-shaped structure, the hinge is opened gradually. The opening angle of the hinge can be adjusted by changing design parameters as needed in use.

### Example 2

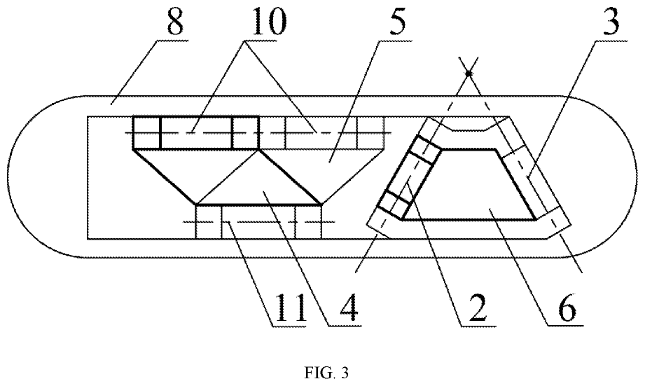

As shown in FIG. 3, based on the principle of example 1, there may be one or more folded leaves formed after the upper leaf 6 and lower leaf 7 are hinged and assembled. With the design of one folded leaf to realize an opening and closing movement trajectory, on the one hand, the strength of the hinge may be improved by increasing the dimensions of the upper support arm 4 and the lower support arm 5 without changing the overall dimensions; and on the other hand, the overall design dimensions are reduced while ensuring the strength of example 1.

### Example 3

Based on the technical solution of example 1, there may be one or more folded arms formed after the upper support arm 4 and lower support arm 5 are hinged and assembled. The strength of the hinge can be improved through either the increase of the quantity of the folded arms or the increase of the design dimensions of the upper support arm 4 and the lower support arm 5, but the former has the advantages of optimal interchangeability and better flexibility in mounting and use.

1. A concealed hinge with V-shaped rotating shafts, comprising:
an upper leaf and an upper support arm that are hinged to a secondary hinge, and a lower leaf and a lower support arm that are hinged to a primary hinge, wherein the upper leaf is hinged to the lower leaf; and
wherein the upper support arm is hinged to the lower support arm.

2. The concealed hinge with V-shaped rotating shafts according to claim 1, wherein there is one or more folded leaves formed after the upper leaf and lower leaf are hinged and assembled.

3. The concealed hinge with V-shaped rotating shafts according to claim 1, wherein there is one or more folded arms formed after the upper support arm and lower support arm are hinged and assembled.

4. The concealed hinge with V-shaped shafts according to claim 1, wherein:
a hinged joint at an end of the upper leaf is connected, by means of a shaft, to a hinged seat secured to the secondary hinge;
a hinged joint at one end of the lower leaf is connected, by means of a shaft, to a hinged seat secured to the primary hinge, and a hinged joint at the other end of the lower leaf is connected to the upper leaf by means of a shared shaft;
one end of the upper support arm is connected, by means of a side shaft, to the hinged seat secured to the secondary hinge, and a hinged joint at the other end of the upper support arm is connected to the lower support arm by means of a longitudinal shared shaft; and
a hinged joint at an end of the lower support arm is connected, by means of a side shaft, to the hinged seat secured to the primary hinge.

5. The concealed hinge with V-shaped rotating shafts according to claim 1, wherein the shared shaft for the folded secondary hinge and primary hinge and two shafts intersect at a point.

6. The concealed hinge with V-shaped rotating shafts according to claim 1, wherein a groove capable of accommodating folded upper leaf and lower leaf and folded upper support arm and lower support arm is formed in the primary hinge.

7. The concealed hinge with V-shaped rotating shafts according to claim 1, wherein a groove capable of accommodating folded upper leaf is formed in the lower leaf.

8. The concealed hinge with V-shaped rotating shafts according to claim 1, wherein mounting holes or threaded holes are formed in the secondary hinge and the primary hinge.
